(19) United States
(12) Patent Application Publication
(10) Pub. No.: US 2019/0362310 A1
(43) Pub. Date: Nov. 28, 2019

(54) FREIGHT-FORWARDER MONITORING AND MANAGEMENT SYSTEMS AND METHODS

(71) Applicant: Flexport, Inc., San Francisco, CA (US)

(72) Inventors: Patrick Steigler, Oakland, CA (US); Suneet Rockwood Dewan, San Francisco, CA (US)

(21) Appl. No.: 16/420,893

(22) Filed: May 23, 2019

Related U.S. Application Data
(60) Provisional application No. 62/675,457, filed on May 23, 2018.

(51) Int. Cl. G06Q 10/08

(52) U.S. Cl. CPC G06Q 10/08345

(57) ABSTRACT

In an embodiment, the methods and systems disclosed herein utilize a cloud-based service to receive data relating to freight shipping on behalf of a supplying entity by one or more shipping entities. In an embodiment, a computer system determines utilization data for the shipping entity corresponding to a first distinct time period and a second distinct time period. In an embodiment, a computer system determines data relating to differences in utilization data between the first and second distinct time periods. In an embodiment, the computer system displays a graphical visual representation of the differences in utilization data.

### BENEFIT CLAIM

This application claims the benefit under 35 U.S.C. § 119(e) of provisional application 62/675,457 filed May 23, 2018, the entire contents of which is hereby incorporated by reference for all purposes as if fully set forth herein.

### TECHNICAL FIELD

One technical field of the present disclosure is freight shipping and management. Another technical field is freight shipping logistics and cost management. Another technical field is logistic data management and improvement.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Items in commerce are any items, objects, products, work-product, or tools that are transported from one location to another as part of a commercial transaction or contract. The modern freight shipping industry involves transporting copious amounts of items and products to and from various locations around the world and often across numerous borders. As a result, modern shipping processes must track and manage large amounts of logistical information including cost, time, and efficiency, as well as physical objects in order to efficiently and accurately transport those objects from one location to another.

A supplying entity or supplier is a company or commercial entity that sells and transports items in commerce as a regular business activity. As suppliers grow and become more sophisticated, they may employ shipping entities such as freight forwarders to transport commercial items on the supplier's behalf to reduce the supplier's commercial responsibilities. A freight forwarder is a shipping entity that physically moves the commercial item from an origin to a destination (intermediate or final). Larger supplying entities having multiple business locations may need to employ multiple shipping entities to carry a larger number of commercial items due to geographic constraints. Other factors which weigh on the decision to employ freight forwarders include actual location of the supplier and freight forwarders, shipping specialties of the freight forwarders, volume capacity of the freight forwarders, use of special equipment for shipping, seasonal shipping trends, etc.

The act of employing a particular freight forwarder to carry goods on a supplier's behalf is utilization of that particular freight forwarder. As suppliers and freight forwarders grow larger, greater degrees of variance in utilization of freight forwarders begin to appear in shipping trends. Variances in utilization are changes in employment of individual freight forwarders measured between two time periods. For example, the amount of goods that a freight forwarder commercially transports may vary at different times of the year. Such variances may be attributable to a wide variety of circumstances and may indicate, for example, that a freight forwarder has been overperforming or underperforming a supplier's commercial expectations, and/or may be indicative of a change in commercial shipping protocols from the supplier.

Variances in utilization are therefore important metrics to determine in order to determine the logistic trends of a supplier and/or freight forwarders. Conventional methods of determining variances in utilization involve manual human guesswork to determine how a supplier's interactions with one or more freight forwarders are changing over time. A human manager may view raw shipping data from one or more sources and attempt to discern various aspects of freight forwarder utilization on their own. Human error in interpreting shipping data and drawing conclusions based on misleading data may lead to an improper determination of variances in utilization. Such improper determinations will lead to poor corresponding management of freight forwarder utilization in the present and future. Furthermore, manually attempting to guess trends and make decisions regarding future utilization of freight forwarders may subject both suppliers and freight forwarders to counterproductive practices, such as overutilizing underperforming forwarders, underutilizing overperforming forwarders, employing new freight forwarders during period of high volatility, etc. Therefore, there exists a need in the field of commercial shipping and transportation for a computer implemented method to automatically extract and process relevant freight forwarder data. There exists a further need in the field to determine periods and trends relating to utilization volatility and variances of freight forwarders shipping data. There exists a further need in the field for automatic recommendations and/or updates of utilization practices based on utilization data, and displayed in an effective readable and discernable manner for human and computer operators alike.

### BRIEF DESCRIPTION OF THE DRAWINGS

In the drawings:

FIG. 1 depicts a system that may be used to implement an embodiment.

FIG. 2 depicts an example process that may govern the operation of an embodiment.

FIG. 3 depicts an example general purpose computer system that may be used to implement aspects of an embodiment.

FIG. 4 depicts an example embodiment that may be used in implementing the example process.

FIG. 5 depicts an example embodiment that may be used in implementing the example process.

FIG. 6 depicts an example process that may govern the operation of an embodiment.

FIG. 7 depicts an example embodiment that may be used in implementing the example process.

FIG. 8A depicts an example embodiment that may be used in implementing the example process.

FIG. 8B depicts an example embodiment that may be used in implementing the example process.

FIG. 9 depicts an example embodiment that may be used in implementing the example process.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are depicted in block diagram form in order to avoid unnecessarily obscuring the present invention.

### General Overview

Embodiments are described herein in the context of items in commerce (“freight”) for purposes of explanation, but embodiments are not limited to freight per se, and are applicable to any item of commerce. In various embodiments of the techniques herein, a computer implemented method is used to collect and determine data regarding a supplier's utilization of various freight forwarding companies for shipping freight. The data comprises the total numbers of freight and, explicitly or implicitly, proportions of freight that each freight forwarder has shipped on behalf of the supplier during two or more time periods.

The collected shipping data is used to determine utilization data regarding the utilization of the various freight forwarding companies during a first time period. Utilizing a freight forwarder during a first period of time means the freight forwarder has shipped at least some freight commercially on behalf of the supplier during the first period of time. The utilization of each freight forwarder during the first period of time is represented by the determined utilization data.

The collected shipping data is then used to determine data regarding the utilization of the various freight forwarding companies during a second time period, which is different than the first period of time. Utilizing a freight forwarder during a second period of time means the freight forwarder has shipped at least some freight commercially on behalf of the supplier during the second period of time. The utilization of each freight forwarder during the second period of time is represented by the determined utilization data. Utilization may be different between the first and second periods, for example some freight forwarders may have shipped more freight on behalf of the supplier during the second period of time than the first period of time. Other freight forwarders may have shipped less freight during the same period of time. New freight forwarders may have been added to the list of existing freight forwarders during the second period to ship freight, and previous freight forwarders employed in the first period may not be included in commercial activities during the second period.

The determined utilization data for the first and second periods of time is used to determine difference utilization data corresponding to changes in utilization between the first and second periods of time. The difference utilization represents the difference in volume that certain freight forwarders shipped, whether more, less, or similar amounts of freight for the supplier in the second time period compared to the first time period. The difference utilization data may use raw freight numbers, proportional utilization or other data metrics to show how utilization of individual or collective freight forwarders has changed, including the degree of changes between the time periods.

The computer implemented system generates a graphical visual representation of the difference utilization data to depict the differences in freight forwarder utilization to a human user or a computer utilizing trend prediction data. The graphical representation depicts, in an efficient and effective format for viewing, the notable trends in freight forwarder utilization to inform on the nature of freight forwarding practices and suggest productive alternatives to current protocols for suppliers and freight forwarders alike.

The difference utilization data may include a volatility metric. The volatility metric includes compiled difference utilization data calculated in a format such that a freight forwarder delta is determined. The freight forwarder delta shows the total change in all freight forwarder utilization over a period of time. The higher the change in utilization of the collective freight forwarders is across time periods, the higher the volatility the supplier is experiencing in utilizing freight forwarders to ship freight, and the higher the corresponding freight forwarders delta will be. Based on trends or predictions according to the freight forwarder delta, new practices might be implemented, or alternative management plans may be proposed to efficiently improve efficient utilization of the various freight forwarding companies.

System Implementation

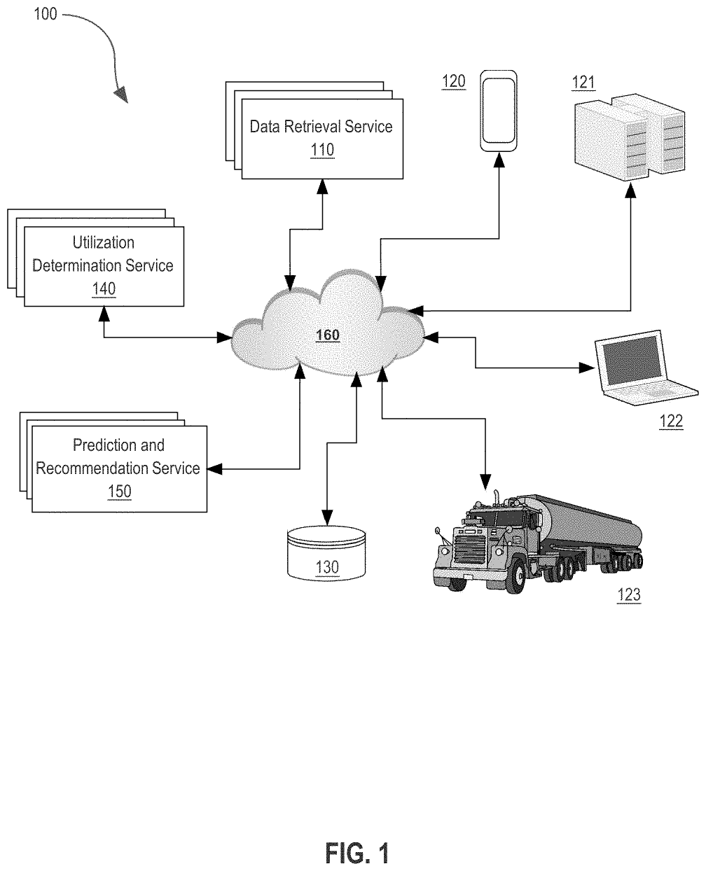

FIG. 1 depicts an example system 100 for the determination and utilization of freight forwarder utilization data. Network 160 connects devices and systems 110-150. Network 160 may be any appropriate local area network, internet, intranet, cloud network, and/or other type of network or communication mechanism capable of facilitating communication between electronic entities, including those discussed herein. Network 160 may allow the facilitation of a cloud-based service that uses devices, systems, and services 110-150 to manipulate freight forwarder utilization data and share the data among devices connected to cloud-network-based architecture.

Coupled to network 160 is data retrieval service 110. Data retrieval service 110 may be any device, system, or entity that is capable of retrieving data which represents or can be manipulated to represent utilization data for freight forwarders over various periods of time. In various embodiments, data retrieval service 110 is a cloud-based computing service operating across one or more devices to track freight forwarder utilization in real-time or retrieve existing data regarding utilization. In various embodiments, data retrieval service 110 is a service integrated into a computer application, the computer application used to track utilization of freight forwarders or retrieve existing data regarding utilization. In various further embodiments, the computer application is installed across various devices communicatively coupled together over network 160 and facilitates sharing, updating, modifying, and alerting other devices implementing the computer application to the existence of freight forwarder utilization data. In various further embodiments, data retrieval service 110 is configured to receive historical data regarding freight forwarder utilization in order to compare historical trends in freight forwarder utilization against contemporary data.

Utilization determination service 140 is connected to network 160. Utilization determination service 140 may be any device, system, cloud-based program, or entity capable of storing, maintaining, analyzing, modifying, manipulating or updating data related to freight forwarder utilization. In various embodiments, utilization determination service 140 communicates directly with data retrieval service 110 over network 160 or any other sufficient connective entity to send and receive information that is used in the determination of data relating to freight forwarder utilization. In various embodiments, utilization determination service 140 is a cloud-based storage system capable of communicating to various devices connected to a cloud-architecture information related to determination of freight forwarder utilization over a period of time. In various further embodiments, utilization determination service 140 uses data from data retrieval service 110 to determine utilization data which indicates the volatility of a suppliers use of freight forwarders.

Prediction and recommendation service 150 is connected to network 160. Prediction and recommendation service 150 may be any device, system, or entity capable of accepting, inputting, receiving, or facilitating information related to trends or data regarding freight forwarder utilization. In various embodiments, prediction and recommendation service 150 is used to analyze trends in data from utilization determination service 140 and/or data retrieval service 110. In various further embodiments, prediction and recommendation service 150 is a service integrated into a computer application, the computer application used to receive data from utilization determination service 140 and/or data retrieval service 110 and provide a user of the computer application with suggestions or extrapolations related to freight forwarder utilization data. In various further embodiments, the prediction and recommendation service 150 is two separate services, one for predicting trends in freight forwarder utilization data and another for making recommendations or implementing recommendations for future freight forwarder utilization.

Devices 120-123 are connected to network 160. Devices 120-123 may be any device, system, or entity that may further aid in the determination and implementation of freight forwarder utilization data. Device 120 may be a smartphone capable of using a computer application that may facilitate display of freight forwarder utilization data to a user. For example, device 120 may be employed by a management entity in a supplier or freight forwarder organization to view a graphical visual representation of freight forwarder utilization or volatility of the supplier based on data from utilization determination service 140 and received over network 160.

Device 121 may be a series of servers or computing devices that store, for access, various data such as data that may be retrieved by data retrieval service 110. In an additional example, device 121 may be a series of servers that host cloud-based services, such as the services described herein, and facilitates communication of cloud-based information to various cloud connected devices, such as devices 120-123. Device 122 may be a personal computing device utilized to data related to freight forwarder utilization. For example, device 122 may be used to view raw shipping numbers according retrieved by data retrieval service 110 to ensure data can be sent to utilization determination service 140. Commercial vehicle 123 may be a commercial vehicle including built-in technology or connectivity devices that can communicate over network 160 to send or receive relevant information to the generation of a commercial transport cost plan. For example, data retrieval service 110 may use on-board computing devices in commercial vehicle 123 to track freight delivery and freight forwarder utilization in real time.

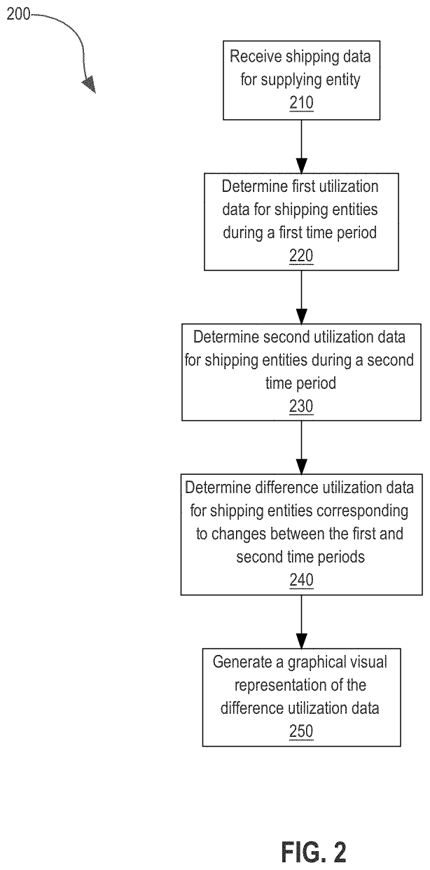

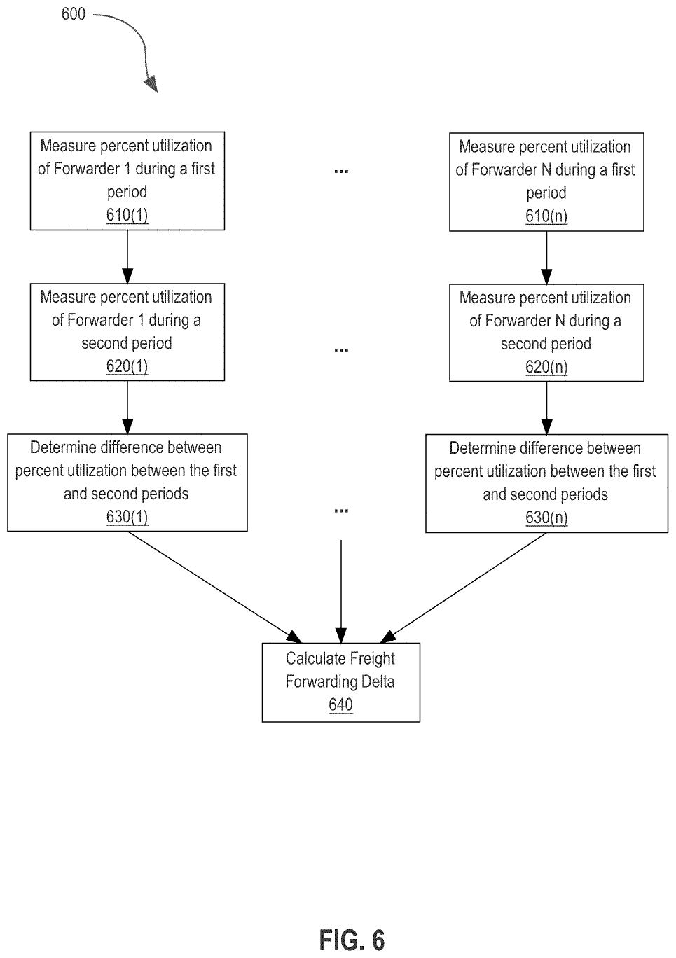

Storage 130 is connected to network 160. Storage 130 may be any storage device, software, application, or entity that is capable of storing digital information. In various embodiments, storage 130 may replace any other entity in example system 100 that allows the storage of digital information. For example, storage 130 may store in an electronic memory, freight forwarder utilization data as part of processes described herein. In various embodiments, the example system 100 as described herein executes the steps of process 200 or process 600, depicted in FIG. 2 and FIG. 6 respectively.

Process Overview

FIG. 2 depicts an example process 200 that may govern operation of an embodiment. Process 200 begins with receiving 210 shipping data corresponding to a shipping entity. Received shipping data is then used to determine 220 first utilization data for shipping entities shipping freight on behalf of the supplier during a first period. Received shipping data is then used to determine 230 second utilization data for shipping entities shipping freight on behalf of the supplier during a second period. Based on the first and second utilization data, difference utilization data is determined 240 corresponding to differences in shipping entity utilization between the first and second time periods. The difference utilization data is then used to generate 250 a graphical visual representation depicting the difference in utilization data over the two time periods.

Returning to step 210, the computer system receives shipping data corresponding to a shipping entity. In various embodiments, step 210 is performed by a computing device utilizing data retrieval service 110. In various further embodiments, data retrieval service 110 is implemented as a cloud-based service. Shipping data may be any data or information necessary to convey commercial activities of shipping entities for shipping freight on behalf of a supplier. In various embodiments, the shipping data conveys total units of freight shipped on behalf of a supplier. In various embodiments, the shipping data may be a manifest or compiled list of all commercial transactions or operations between a supplier and a shipping entity over multiple periods of time. For example, a shipping manifest for individual jobs may specify an amount of freight delivered by a freight forwarder on behalf of a supplier during a period of time. In various further embodiments, a shipping manifest may include data or information comprising multiple freight forwarders involved in commercial shipping on behalf of a supplier during a time period.

In various embodiments, receiving shipping data comprises compiling shipping data received from one or more sources over one or more period of time. For example, a computer device implementing data retrieval service 110 may store received shipping data in a shared memory such as storage 130. Data retrieval service may then receive shipping data at a future period of time and combined the received shipping data from the future period with the store shipping data to create a compiled shipping data manifest.

In various embodiments, receiving shipping data comprises tracking shipping entity utilization in real time using one or more devices which can track information relating to freight shipping. For example, systems built into commercial vehicles 123 may report the status of a commercial shipping job untaken by a freight forwarder on behalf of a supplier in real time by specifying the location of commercial vehicle 123 during a standard delivery. A delivery drive may input the status of shipped freight before and/or after a shipping transaction is complete at device 120. In various further embodiments, data retrieval service creates a blank manifest which will be filled with shipping data in real time. The status of a shipping job may be updated frequently and sent to data retrieval service 110. Data retrieval service 110 will then populate the blank manifest with real-time shipping data.

In various embodiments, the totality of shipping data by various shipping entities on behalf of a supplier is received completely or nearly all at once. For example, a quarterly billing manifest for a supplier may specify each shipping entity a supplier contracted with during a quarterly period and the amount of freight moved for each of those shipping entities. In various embodiments, receiving shipping data comprises accessing a publicly available or proprietary data service or server which houses shipping data relating to freight shipping for shipping entities on behalf of a supplier. In various further embodiment, data retrieval service automatically accesses a data service or server at regular intervals to retrieve or compile shipping data to be used as part of process 200.

In various embodiments, receiving shipping data comprises receiving data from each of the shipping entities which commercially shipped freight on behalf of the supplier. In various further embodiments system 100 collects the received data from each of the shipping entities separately and compiles the data into a singular shipping manifest detailing the utilization of each of the shipping entities. For example, data retrieval service may automatically dispatch a freight manifest request to each utilized shipping entity at a regular time interval. The freight manifest request queries for data from each of the shipping entities corresponding to freight shipping on behalf of the supplier during the most recent time period for shipping freight. In various embodiments, freight manifest queries occur at the beginning and/or end of each relevant time period.

At step 220, the computer system uses the received shipping data to determine first utilization data for shipping entities shipping freight on behalf of the supplier during a first period. First utilization data may be any data or information sufficient to convey the commercial shipping activities of one or more shipping entities on behalf of the supplier during the first time period. In various embodiments, first utilization data comprises data showing the total amount of freight transported by each shipping entity during the first period. In various further embodiments, the first utilization data comprises data representing a proportion of a supplier's total commercial shipments performed by an individual shipping entity. For example, the proportion of a supplier's total commercial shipments may be the percentage of items that were shipping on behalf of a supplier during a period of time. In various further embodiments, the first utilization data represents proportions for each utilized shipping entity, wherein the summation of total utilization of each individual shipping entity adds up to one hundred percent, representing the total utilization of shipping entities by a supplier. In various embodiments, the summation of total utilization of each individual shipping entity adds up to less than one hundred percent if the supplier shipped freight on its own behalf of using means outside of any shipping entities purview. For example, a shipping entity which has shipped twenty of a supplier's total one hundred units of freight shipped during a first time period will have a utilization percentage of twenty percent out of a possible one hundred percent if all shipping was performed by shipping entities. The remaining eighty percent of shipped freight may be represented in the first utilization data by a remaining plurality of individual shipping entities. Thus, each remaining shipping entity utilized to ship freight of behalf of a supplier will have utilizations totaling eighty percent.

At step 230, the computer system uses the received shipping data to determine second utilization data for shipping entities shipping freight on behalf of the supplier during a second period. Second utilization data may be any data or information sufficient to convey the commercial shipping activities of one or more shipping entities on behalf of the supplier during the second time period. In various embodiments, second utilization data comprises data showing the total amount of freight transported by each shipping entity during the second period. In various further embodiments, the second utilization data represents a proportion of a supplier's total commercial shipments performed by an individual shipping entity.

In various further embodiments, the second utilization data represents proportions for each utilized shipping entity adding up to one hundred percent, similar to the first utilization data. For example, the shipping entity which had shipped twenty of a supplier's total one hundred units of freight shipped during the first time period may have shipped fifty of a suppliers total one hundred units of freight during a second time period, therefore giving the shipping entity a utilization percentage of fifty percent out of a possible one hundred percent. The remaining fifty percent of shipped freight may be represented in the second utilization data by the remaining plurality of individual shipping entities which may include new or old shipping entities from the first utilization data. In various embodiments, the second utilization data may have similar characteristics of the first utilization data discussed herein. In various embodiments, the second utilization data has one or more different characteristics than the first shipping data. For example, if a supplier shipped freight on its own behalf during the first period, but did not ship freight on it's own behalf during the second period, utilization percentages during the first period may not add up to one hundred percent, but utilization percentages during the second period may add up to one hundred percent.

At step 240, based on the first and second utilization data, the computer system determines difference utilization data corresponding to differences in shipping entity utilization between the first and second time periods. Difference utilization data may be any data which conveys one or more aspects of a degree of change or changes between the first utilization data and the second utilization data. In various embodiments, these changes occur over the course of the time occurring between the first and second time periods. In various embodiments, difference utilization data comprises raw freight shipping numbers specifying the difference in total shipped units of freight by a shipping entity between the first and second period. In various embodiments, difference utilization data comprises differences in percentile or proportional utilization of a shipping entity between the first and second time period. As in the example above, a shipping entity having a utilization percentage of twenty percent during the first period of time and a utilization percentage of fifty percent during the second period of time represents a difference in utilization of the entity. Difference utilization data may be determined having a difference percentile of thirty percent corresponding to the difference in utilization percentiles between the two periods for the shipping entity.

In various embodiments, difference utilization data comprises such difference percentage values or some or all of a group of shipping entities shipping freight commercially on behalf of a supplier. In various embodiments, the difference utilization data comprises differences measured between individual shipping entities. In various embodiments, the difference utilization data comprises differences between utilization of a suppliers own shipping channels to ship freight on its own behalf. In various embodiments, the difference utilization data is scaled based on the difference in time periods or the difference in the supplier's commercial business size. For example, a small supplier may be expected to experience higher amount of difference utilization as the business grows and expands its shipping network. A coefficient accounting for small business entities may be employed in such a situation to scale difference utilization data to an amount representing relative difference in utilization based on size. In various embodiments, the difference utilization data comprises measured differences in various metrics of freight shipment undertaken by shipping entities, such as total distance traveled, average distance traveled, total price of shipment, average price of shipment, total amount of freight transported, average amount of freight transported, commercial vehicles utilized, etc.

At step 250, the computer system generates graphical visual representation depicting the difference utilization data over the two time periods. The graphical visual representation may be any visual representation which conveys some aspect of the difference utilization data to a human or computer system. In various embodiments, the graphical visual representation is a graph. In various further embodiments, the graph is a graph having two scaled axes. In various further embodiments the graphical visual representation is a bar graph. In various further embodiments, the graphical visual representation is a line graph. In various further embodiments, the graph shows difference utilization data corresponding to differences in raw shipping numbers between a first and second time period for one or more shipping entities. In various further embodiments, the graph shows difference utilization data corresponding to differences in proportional or relative percentile utilization for several shipping entities. In various further embodiments, the graph shows difference utilization data corresponding to changes in volatility according to changes in a calculated freight forwarder delta value across different time periods.

In various embodiments, the graphical visual representation is presented to a human user of a computing device. In various further embodiments, the human user can manage and modify the manner in which the computing device presents the graphical visual representation. Such a change may more accurately and efficiently view relevant information conveyed by the graphical visual representation. For example, a user seeking volatility information between a first and second time period may control the graph to display difference utilization data which only corresponds to differences between the first and second time period. In various embodiments, a user may parameterize aspects of the graphical visual representation before it is displayed. In various embodiments, a user may parameterize aspects of the graphical visual representation as it is being displayed. In various embodiments, the graphical visual representation is presented to the human on any of devices 120-123.

In various embodiments, the graphical visual representation is presented in a format recognizable by a computer system. In various further embodiments, a computer may receive the graphical visual representation or optically scan the graphical visual representation in order to recognize and process information relating to the difference utilization data portrayed in the graphical visual representation. For example, a computer device may scan the graphical visual representation to discern a trend in the difference utilization data which is occurring over a period of months according to the format in which the difference utilization data is conveyed. for example, a computer system may optically scan or parse pixels in the graphical visual representation to determine the direction, magnitude or pattern of a visual shape in order to recognize some aspect of the difference utilization data. In various further embodiments, a computer system may predict future trends based on recognized data depicted in the graphical visual representation. For example, an optical pixel analysis of trend lines in a graphical visual representation may be used to guess with a percent certainty the likelihood that a future graphical visual representation will follow a hypothetical path. A computer system may recognize that a graphical visual representation in a line graph format and having an average slope of 0.5 between various periods will have some percentile chance of having a slope of 0.5 during a measured future period.

FIG. 6 depicts an example process 600 that may govern operation of an embodiment. Process 600 builds on process 200 by using computer implemented methods to calculate volatility in shipping entity utilization and represent such volatility with a freight forwarder delta. Process 600 begins by measuring 610(1) a percent utilization of an individual shipping entity during the first time period based on the first utilization data. A percent utilization of the individual shipping entity is then measured 620(1) during a second time period based on the second utilization data. A difference in percent utilization between the first and second periods is determined 630(1) corresponding to a change in the proportion of freight shipped by the shipping entity between the periods. Concurrent measurements for and determinations for other individual shipping entities utilized by a supplier may be made 610(n)-630(n). Each determined difference of percent utilization is then used to calculate 640 a freight forwarding delta corresponding to the total change in proportional utilization experienced by a supplier between the first and second time periods.

Returning to step 610, a percent utilization of an individual shipping entity during the first time period based on the first utilization data is measured. In various embodiments, measuring 610 may be done as part of step 220 of process 200. In various embodiments, the percent utilization of a shipping entity during the first period may be the proportion of freight that a shipping entity ships on behalf of a supplier compared to the total freight shipped on the supplier's behalf by any shipping entities during the first period. For example, a first forwarder (Forwarder 1) may ship a total amount of freight on behalf of a supplier during a first period that is equal to twenty percent of a supplier's total freight shipped during a first period. The measured percent utilization for Forwarder 1 will then be 20%.

At step 620, a percent utilization of the individual shipping entity is measured during a second time period based on the second utilization data. In various embodiments, measuring 610 may be done as part of step 230 of process 200. In various embodiments, the percent utilization of a shipping entity during the second period may be the proportion of freight that a shipping entity ships on behalf of a supplier compared to the total freight shipped on the supplier's behalf by any shipping entities during the second period which may be different than the first period. For example Forwarder 1 may ship a total amount of freight on behalf of a supplier during a second period that is equal to fifty percent of a supplier's total freight shipped during a first period. The measured percent utilization for Forwarder 1 will then be 50%.

At step 630, a difference in percent utilization between the first and second periods is determined corresponding to a change in the proportion of freight shipped by the shipping entity between the periods. In various embodiments, measuring 630 may be done as part of step 240 of process 200. In various embodiments, the difference in percent utilization of a shipping entity between the first and second period may be the difference in proportion of freight that a shipping entity ships on behalf of a supplier during the second period compared to the first period. For example, because Forwarder 1 has measured percent utilization of 20% during the first time period and a measured percent utilization of 50% during the second time period, the difference in percent utilization is 30% or 0.3. An equation to determine difference between percentile utilization for an individual shipping entity may be:

D1=P2−P1=(Fs2/Tf2)−(Fs1/Tf1)

where D1 is the different in percentile utilization for the individual freight forwarder (Forwarder 1), P2 is the percent utilization of Forwarder 1 during the second time periods, P1 is the percent utilization of Forwarder 1 during the first time period, Fs2 is the total freight shipped by Forwarder 1 during the second time period, Tf2 is the total freight shipped on behalf of the supplier during the second time period, Fs1 is the total freight shipped by Forwarder 1 during the first time period, and Tf1 is the total freight shipped on behalf of the supplier during the first time period.

In various embodiments, multiple steps in process 600 are completed concurrently or sequentially for each shipping entity which ships freight on behalf of a supplier. For example, if a supplier uses a plurality of shipping entities to move freight on its behalf (a total of N shipping entities), there may be N instances of process 600 to complete for each of the qualifying shipping entities. For example, steps 610(n)-630(n) are similar to steps 610(1)-630(1) for a freight forwarder (Forwarder N) which has shipped freight on behalf of the supplier during the first and second time periods.

At step 640, each determined 630 difference of percent utilization for each of the qualifying freight forwarders, 1-N, is used to calculate a freight forwarding delta corresponding to the total change in proportional utilization experienced by a supplier between the first and second time periods. The freight forwarding delta (FF Delta) may be any value, data, or enumerated representation sufficient to convey the relationship between changes among the plurality of qualifying freight forwarders. For example, the FF Delta may be a summed amount of the differences in percent utilization to convey a scale of volatility that a supplier is experiences in utilization of freight forwarders. In various embodiments, the FF Delta is the sum of the absolute values of each difference in percent utilization between a first and second time period. An equation to calculate and FF Delta may be:

FF=|D1|+|D2|+ . . . +|Dn|

where FF is the FF Delta value and D1, D2, Dn are the difference in percent utilization for each freight forwarder calculated in the manner discussed above.

In various embodiments FF Delta is calculated as a summation of the absolute values of the raw differences in total freight units shipped by each shipping entity. In various embodiments, the FF Delta is calculated according to weighted values for each shipping entity corresponding to each shipping entity's utilization by the supplier relative to other shipping entities. In various embodiments, the FF Delta is calculated according to weighted values for new shipping entities which have been added in a second period which were not utilized in the first period. In various embodiments, the FF Delta is calculated according to weighted values for shipping entities which were not utilized in the second time period but were utilized the first time period.

### Example Embodiments

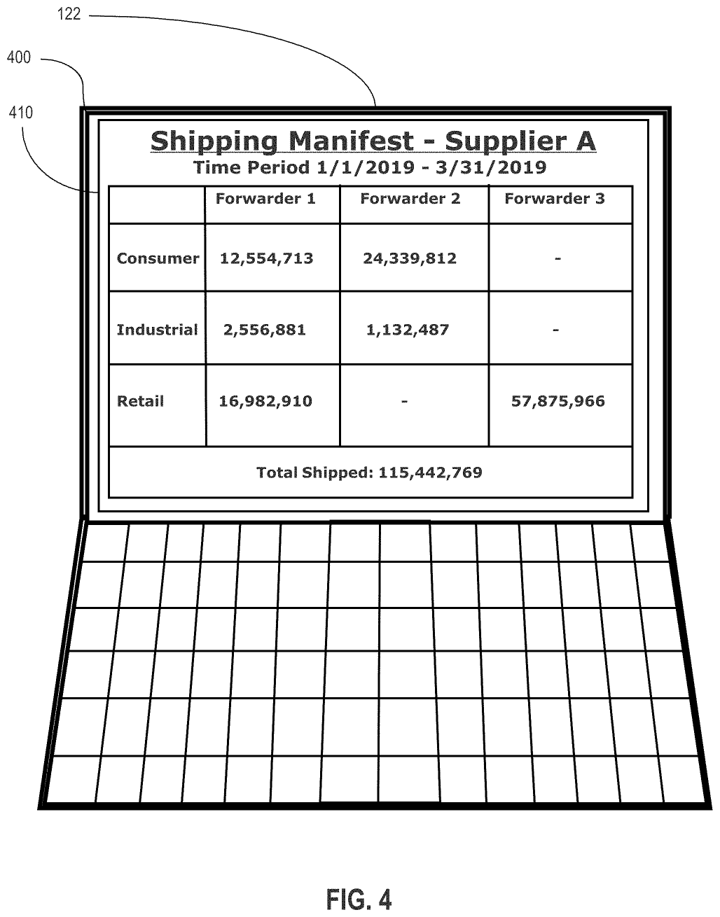

FIG. 4 depicts an example embodiment that may be used in implementing the example processes. Specifically, FIG. 4. depicts device 122 being utilized as a personal computer device to display and manage a shipping manifest showing the utilization of various freight forwarders by a supplier.

As depicted in FIG. 4, a shipping manifest 410 may be displayed on the screen 400 of device 122. As discussed above, a shipping manifest may be an example of shipping data received as part of step 210 in process 200. In various embodiments, device 122 implements data retrieval service 110 to retrieve, store, and view the manifest data related to shipping entity utilization on the screen 400 of device 122. In various embodiments, the shipping manifest may comprise data which specifies to a user of device 122 relevant aspects of shipping entity utilization which will be used as part of subsequent steps in process 200.

For example, FIG. 4 depicts a shipping manifest 410 which shows freight shipping statistics for supplier company Supplier A. Supplier A has contracted freight forwarders Forwarder 1, Forwarder 2, and Forwarder 3 to ship freight commercially on Supplier A's behalf. The shipments were completed between the time period of Jan. 1, 2019 and Mar. 31, 2019 which is the first period of shipping. In various embodiments, the manifest may further be separated into various categories such as the purpose or nature of freight. For example, FIG. 4 depicts that the manifest has categorized the freight shipped by each of the freight forwarders according to the nature of the freight shipped, such as for consumer deliver, industrial delivery, and retail delivery. As depicted in FIG. 4. different freight forwarders ship freight commercially in different proportions according to the manifest 410. For example, Forwarder 3 has shipped more freight units than Forwarders 1 and 2 in the first period, albeit in the singular sector of retail delivery. In various embodiments, determining differences in percent utilizations 630 may further comprise determining difference in areas of similar freight purpose, such as retail or industrial deliveries by shipping entities.

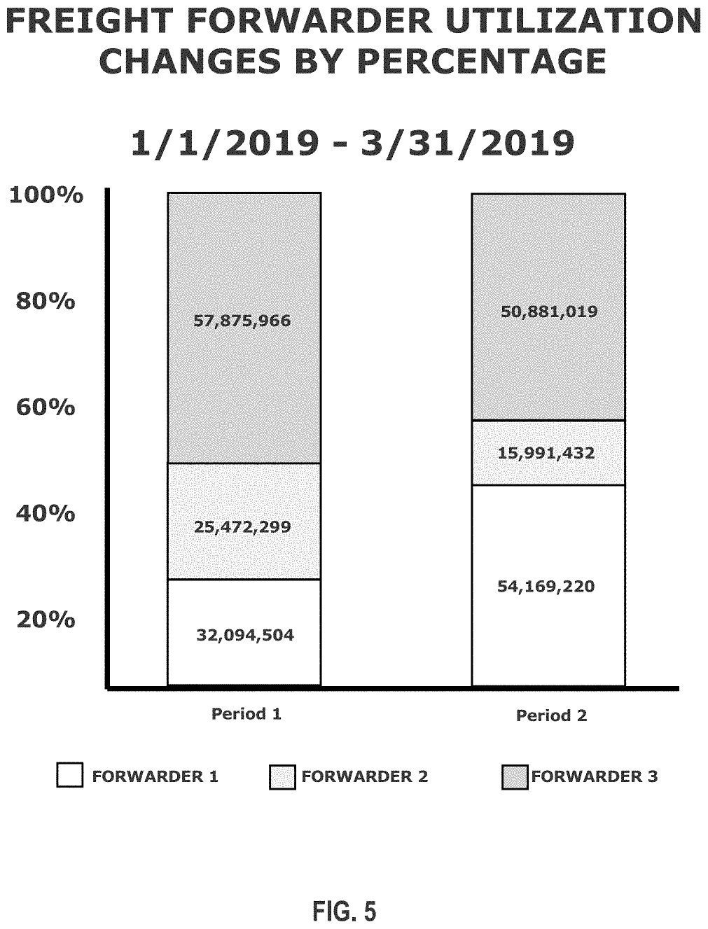

FIG. 5 depicts an example embodiment that may be used in implementing the example processes. Specifically, FIG. 5. depicts a percentile bar graph showing the utilization of the three freight forwarders depicting in FIG. 4 as percentiles between a first and second period. As depicted in FIG. 5, during the first period, each of the three freight forwarders delivered a different proportion of commercial freight on behalf of the supplier and therefore had different percent utilizations. The depiction in FIG. 5 shows data for a second period in which the three freight forwarders also shipped not only different proportions of freight compared to each other, but also compared to the percent utilization during the first period. As a result, Forwarder 1 has a higher percent utilization than Forwarders 2 and 3 in the second time period, which is different than the percent utilizations of the first period. In various embodiments, any computing device, including devices 120-123 may display a graphical visual representation such as the graph depicted in FIG. 5 to convey to a human user, or a computer device, trends and results of utilization data.

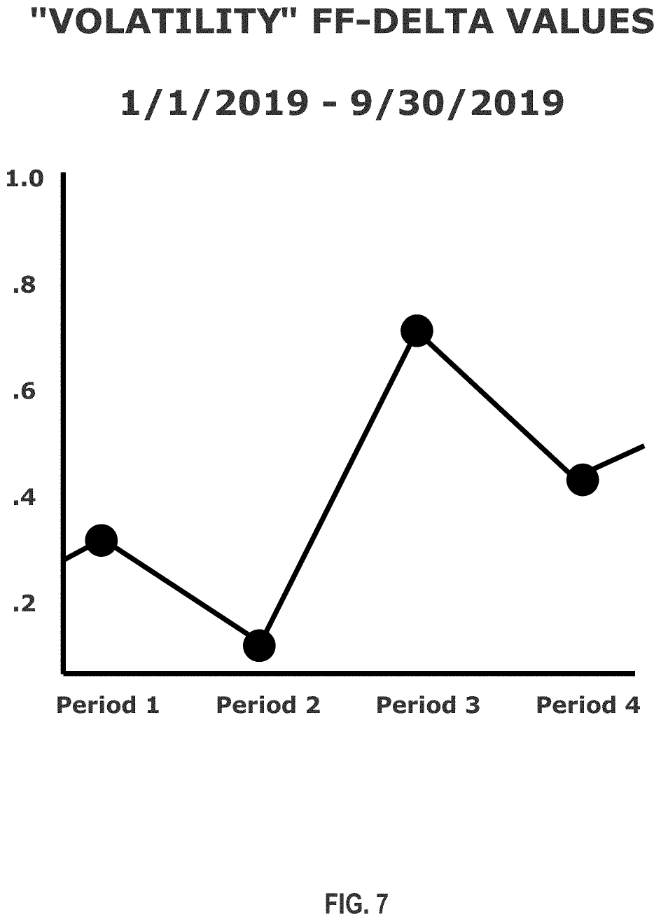

FIG. 7 depicts an example embodiment that may be used in implementing the example processes. Specifically, FIG. 7. depicts a “sliding-window” line graph showing the change of a measured freight forwarder delta over several time periods. In various embodiments the FF Delta is graphed continuously over several time periods to show the rates and trends of volatility in freight forwarder utilization. For example, as shown in FIG. 7, a continuous calculation of the FF Delta as discussed above over several time periods shows the rate of change in volatility of shipping entities over those periods of time. Based on trends in the changes and rates of the FF Delta, certain aspects of a supplier's or a freight forwarders activity may be discovered such as the cyclicality of volatility of an entity. In various embodiments, cyclicality refers to the degree to which an entity follows historical trends in volatility or utilization at similar times or season in different years.

In various embodiments, the sliding scale FF Delta graph is presented to a human user as a graphical visual representation to convey to the user the nature of volatility in freight forwarder utilization. In various embodiments, the sliding scale FF Delta graph is presented to a computer system to analyze trends in the sliding scale to predict or extrapolate additional data about freight forwarder utilization.

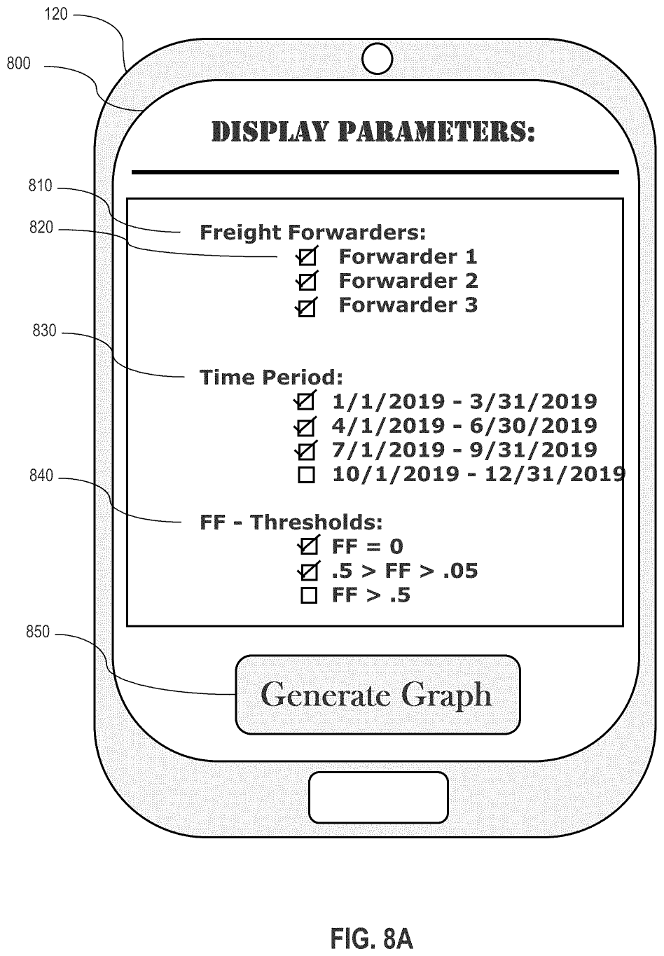

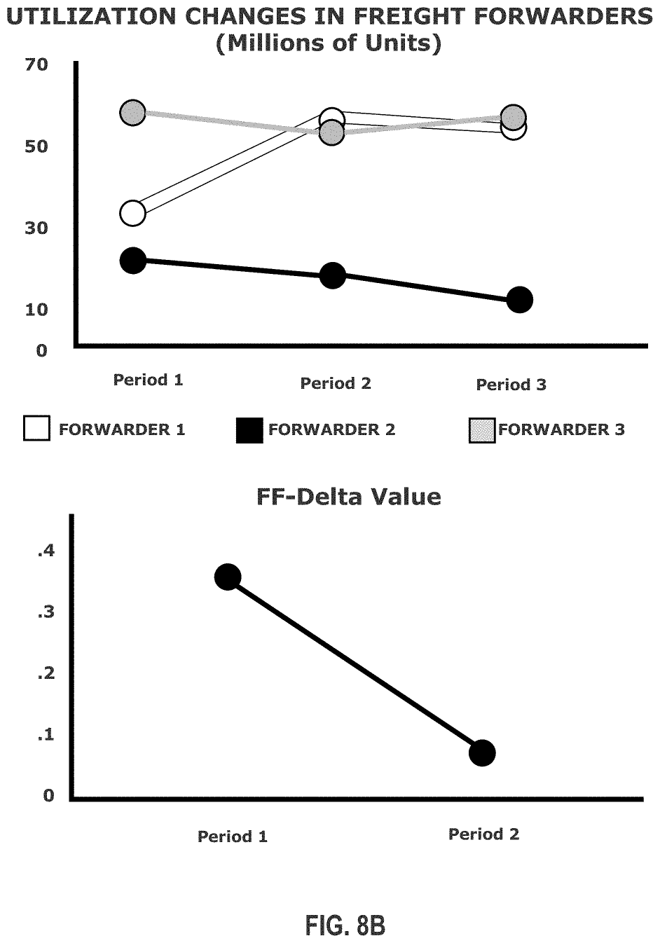

As depicted in, FIG. 8A a visual representation of display parameters that can be used to modify a graphical representation of difference utilization data as may be displayed on the screen 800 of device 120. In various embodiments, device 120 displays the graphical visual representation of difference utilization data on screen 800 of device 120. In various embodiments, the graphical visual representation is modified by changing certain aspects of the graphical visual representation by parameterization of the elements displayed in the graphical visual representation.

Parameterization of the visual display may comprise including or excluding certain aspects of difference utilization data according to the preferences of a user of device 120. A user may select these aspects to be included or excluded manually through some interaction with device 120 through screen 800. The user selections are received as parameterization data and the parameterization data is used to alter the displayed information. For example, device 120 may include freight forwarder parameter 810 as a category showing each qualifying freight forwarder corresponding to data which may be displayed as part of the graphical visual representation. Freight forwarder parameter 810 may include a subset of data selection fields 820 which may or may not be displayed based on user input. For example, freight forwarder parameter 810 in FIG. 8A includes fields for each of Forwarder 1, 2, and 3 which a user may select or deselect manually to include or omit data relating to any of those freight forwarders in the graphical visual representation. As depicted in FIG. 8A, each of Forwarders 1, 2, and 3 are selected, meaning data corresponding to each of those freight forwarders will be included in the graphical visual representation.

Parameterization may include showing or excluding data correspond to certain time periods as shown by time period parameter 830. Time period parameter 830 may include a subset of time periods over which data may be view. For example, differences in utilization data over certain time periods may only be shown corresponding to the time periods selected by a user of device 120. As depicted in FIG. 8A, three time periods are selected, meaning data corresponding to utilization of freight forwarders during those time periods will be shown in the graphical visual representation.

Parameterization may include showing or excluding freight forwarder delta values based on a threshold of volatility as shown by delta threshold parameter 840. Delta threshold parameter 840 may include a subset of FF Delta values thresholds that may be viewed in the graphical visual representation based on the nature of the FF Delta. For example, users seeking to identify only high levels of volatility may select a higher threshold of volatility by selecting a higher FF Delta to be displayed in the graphical visual representation. Users interested in time of low volatility may select only low thresholds for the FF Delta to identify lower periods of volatility. As shown in FIG. 8A, FF Delta thresholds of 0 and between 0.5 and 0.05 are selected, meaning only FF Deltas corresponding to those parameters will be shown in the graphical visual representation.

Once all parameters have been set by a user of device 120, graph generation button 850 may be used to generate graphs showing changes in freight forwarder utilization and measured freight forwarder deltas. In various embodiments, graph generation button 850 may only function when one or more parameters have been selected on device 120. In various further embodiments, the graphical visual representation is premade and updated based on input parameterization fields and the graph generation button 850 updates the premade graphical visual representation.

FIG. 8B depicts an example embodiment that may be used in implementing the example processes. Specifically, FIG. 8B. depicts side-by-side line graphs showing the change of freight forwarder utilization and a measured freight forwarder delta over several time periods according to the parameterization set on device 122 in FIG. 8A. As shown in FIG. 8B, parameterized data corresponding to all three freight forwarders is shown. Additionally, only time periods 1, 2, and 3 are shown in the chart according to the parameterization made at device 120. Additionally, only FF Delta values between zero and 0.5 are shown the corresponding calculated FF Delta chart.

Volatility metrics such as the FF Delta are valuable tools in determining how efficiently a supplier is utilizing various freight forwarders and how vulnerable a supplier is to breakdowns in shipping entity utilization. For example, a high FF Delta corresponding to a higher rate of volatility of shipping entity utilization may convey that a supplier has had difficulty in precuring regular shipping entities for transportation contracts and has hired multiple new or less-used shipping entities to handle freight contracts during a recent period of time. A supplier may view a higher volatility as an indication that current procurement methods of shipping entities is providing a higher liability risk for the supplier. Higher volatility may also indicate that a supplier's current contracting shipping entities are underperforming obligations.

A freight forwarder may view volatility metrics for a supplier to determine whether contracting with a supplier is profitable and safe for a freight forwarder. For example, suppliers having low volatility metrics during recent periods of time may indicate to a freight forwarder that the supplier maintains steady commercial protocols and implements efficient shipping practices, which are desirable traits for a freight forwarder. A freight forwarder may look at high volatility for a supplier as an indication that the supplier has just contract with various new shipping entities and that the freight forwarder has a lower chance of obtaining a contract from a supplier during those periods of high volatility.

Accordingly viewing known and compiled volatility statistics may help suppliers and shipping entities alike change practices which facilitate a more productive partnership between the entities. Similarly, the ability to predict periods of high or low volatility for a supplier offer significant upside for both entities in forming future contracts and managing shipping policies. Various aspects of known and measured shipping data, such as past cyclicality of volatility, portend future results of volatility for suppliers. It is therefore highly beneficial for suppliers and shipping entities alike to project utilization data including volatility for future periods to modify shipping practices and protocols to match future managerial occurrences in the freight shipping field.

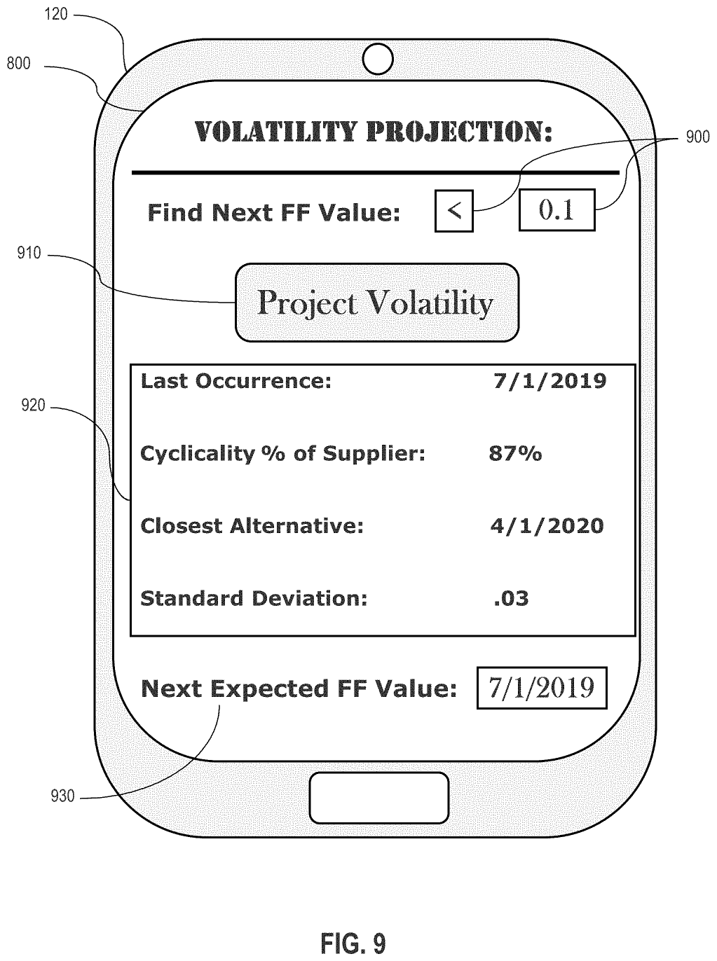

As depicted in FIG. 9, a visual representation of a volatility projection service such as prediction and recommendation service 150 may be displayed on the screen 800 of device 120. In various embodiments, prediction and recommendation service 150 is utilized on device 120 to allow a user to predict a time period when an FF Delta value will occur at a future time period. In various embodiments, prediction and recommendation service obtains difference utilization data which may include FF Delta values for previous time periods. In various embodiments, prediction and recommendation service 150 uses any process of predicting or extrapolating data for a future period of time according to measured difference utilization data, including those processes discussed herein.

In various further embodiments, a user inputs data which will allow the prediction and recommendation service 150 to constraint a prediction or extrapolation search for an FF Delta value at a future time to the user input. A user may input a desired freight forwarder delta value according to delta input 900 on device 120. Delta input 900 may be any field or area into which a user can input data to aid in the prediction of a future FF Delta value. For example, as depicted in FIG. 9, delta input 900 may comprise a first box into which a user can input an operator such as a greater than (>), less than (<), equal to (=), or any combination of the three, symbol which will correspond to a value for FF Delta searches. A second box will allow the input of a threshold FF Delta value corresponding to the operation in the first box. For example, as depicted in FIG. 9, a user desires a prediction of the next time period at which an FF Delta value will be less than 0.1. The user may want to predict or extrapolate a period of relatively low volatility in order to determine at time at which a supplier is expected to experience less volatility. The user has put the corresponding information into delta input 900.

Once the desired freight forwarder delta has been input into delta input 900, projection button 910 may be used to predict the next time period satisfying the corresponding input desired values. In various embodiments, projection button 910 may not function until values are input into each field of delta input 900. The prediction of the next occurring FF Delta value may be based on any information or data relevant to the prediction of an FF Delta value. For example, a high measurement of cyclicality may portend that FF Delta values are highly seasonal and therefore likely to be similar at the same time period in different years.

As another example, prediction and recommendation service 150 may look for other dates where an FF Delta value is expected to be similar to the user input in delta input 900. For example, even if cyclicality is high, an earlier period of time may portend a similar FF Delta value according to historical trends in FF Delta changes. Such predictions may take any number of factors into account including the gaussian distribution of FF Delta value changes, standard deviations, cyclicality, supplier growth or contraction, shipping entity growth or contraction, or any other data or metrics relevant to the prediction of future FF Delta values.

Prediction metric table 920 may show the relevant factors in predicting the next desired freight forwarder delta value. For example, when looking for a predicted FF Delta value, prediction and recommendation service 150 may use the aforementioned factors of previous occurrences, cyclicality, closest alternative date, and standard deviation. In various embodiments, each of the relevant factors in determining the next FF Delta date are shown in prediction metric table 920. In various embodiments, factors not used in determining the predicted future FF Delta date are shown in prediction metric table 920. In various further embodiments, an indicator is used to specify which metrics were used to determine the future FF Delta value and which were not in prediction metric table 920. The future FF Delta value determined may be displayed as an expected freight forwarder delta period on device 120 corresponding to the period of time the predicted FF Delta value will next appear.

The determined expected freight forwarder delta period may be displayed on value display 930. In various embodiments, the next expected freight forwarder delta period is displayed the time period the value is expected to occur at in value display 930. In various embodiments, prediction and recommendation service 150 comprises a protocol recommendation system for certain practices related to determined FF Delta values. For example, a protocol may state that additional freight forwarders should only be hired during expected periods of low volatility because new freight forwarders will change the proportion of shipping freight for each shipping entity and add volatility to a supplier's operations. As a further example, prediction and recommendation service 150 may recommend to a user at device 120 that adding a freight forwarder should be done in the period starting Jul. 1, 2019 as this period will have a lower expected volatility than other periods.

A user utilizing this next expected FF value may have multiple uses for the predicted value. For example, a supplier may know that the sought period of low volatility occurring around Jul. 1, 2019 may be the next period in which to implement new shipping protocols which are expected to raise overall supplier volatility. Implementing the new protocols around this time will balance the expected low volatility with the guaranteed result is rising volatility due to implementing the new protocols. A freight may know that the sought period of low volatility occurring around Jul. 1, 2019 may be the best time to procure a contract with the supplier due to the low volatility period expected to occur around that time.

In further examples, a supplier may search for a next expected period of high volatility to prepare shipping contracts with established shipping entities to attempt to reduce that actual volatility during that period. A freight forwarder may search for a next expected period of high volatility to determine whether the freight forwarder can efficiently undertake the risk of contracting with a volatile supplier during that future time period.

In various embodiments, freight forwarders may utilize prediction and recommendation service 150 to predict periods of time that suppliers will experience lower periods of volatility. In various further embodiments, prediction and recommendation service 150 may provide a recommendation to a freight forwarder to inquire about shipping opportunities from a supplier preceding a period when volatility is expected to be lower. In various embodiments, prediction and recommendation service 150 reassigns certain freight operations or contracts automatically to a different freight forwarder to reduce an expected freight forwarder delta during a future time period. For example, if two freight forwarders carry similar freight and one is being overutilized compared to a previous time period, prediction and recommendation service 150 may automatically assign freight shipping from the overutilized entity to an underutilized entity to preserve volatility of utilization. In various embodiments, a graphical visual representation is also displayed along with the results of projection on screen 800.

In various embodiments, a computer system uses the projections or extrapolations to automatically change protocols within an entity based on the expected volatility value. In an embodiment, in response to projecting a period of low volatility during a particular period, the computer system may generate proposed shipping manifests and/or contracts which increase the efficiency of business practices while keeping volatility in a manageable level. For example, shipping contracts may be generated and presented to a user, those shipping contracts including the hiring of a new freight forwarder during the particular period to improve freight delivery times or expand the reach of the supplier in atypical markets for the supplier. In an embodiment, in response to projecting a period of high volatility during a particular period, the computer system may restrict the generation of manifests and/or contracts which deviate from previous manifests and/or contract from a previous period. The computer system may create a block against certain contracts with particular freight forwarders if the contract deviates from a previous threshold of utilization.

In an embodiment, in response to projecting a period of low volatility during a particular period, the computer system may alter the protocols of a freight forwarder to accept jobs from a supplier having higher risks to the freight forwarder in carrying the freight. For example, a period of low volatility may portend steady commercial contracting for a freight forwarder and allow the freight forwarder to take more ample shipping risks. Many uses for projections and extrapolations are data can be seen in the field of supply chain management, in which projections of commercial activity for suppliers and forwarders aid in the reshaping of protocols and/or practices which improve the efficiency of the commercial shipping supply chain and allow for effective transportation of freight at a faster rate.

Implementation Mechanisms

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

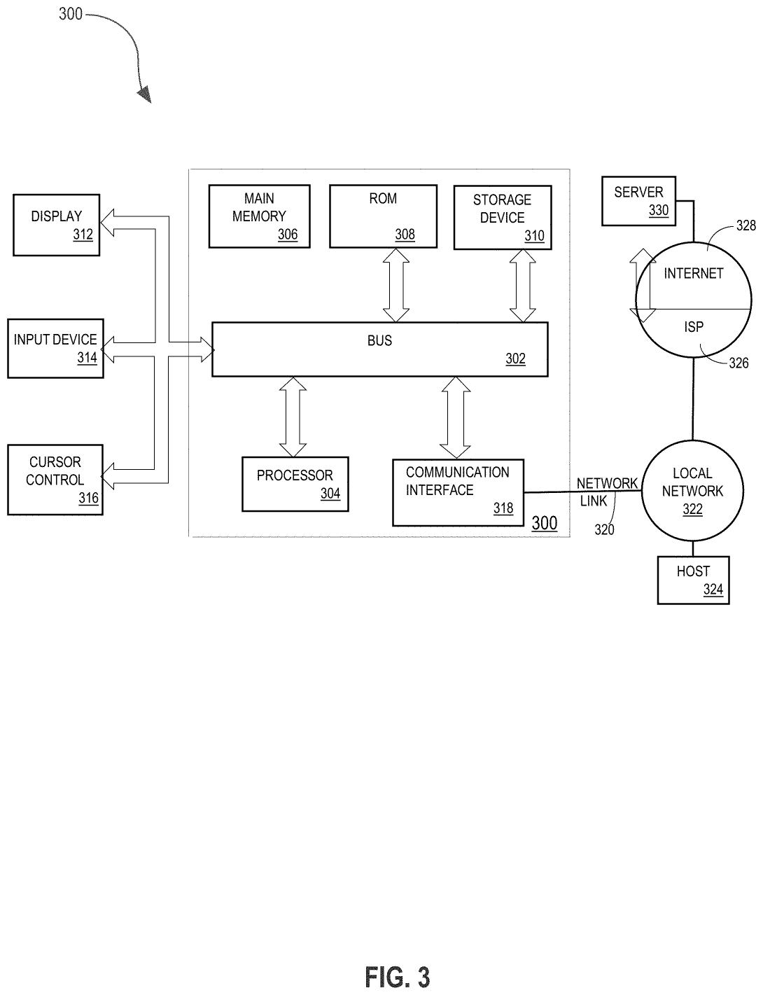

FIG. 3 is a block diagram that depicts an example computer system with which an embodiment may be implemented. In the example of FIG. 3, a computer system 300 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 300 includes an input/output (I/O) subsystem 302 which may include a bus and/or other communication mechanism(s) for communicating information and/or instructions between the components of the computer system 300 over electronic signal paths. The I/O subsystem 302 may include an I/O controller, a memory controller and at least one I/O port. The electronic signal paths are represented schematically in the drawings, for example as lines, unidirectional arrows, or bidirectional arrows.

At least one hardware processor 304 is coupled to I/O subsystem 302 for processing information and instructions. Hardware processor 304 may include, for example, a general-purpose microprocessor or microcontroller and/or a special-purpose microprocessor such as an embedded system or a graphics processing unit (GPU) or a digital signal processor or ARM processor. Processor 304 may comprise an integrated arithmetic logic unit (ALU) or may be coupled to a separate ALU.

Computer system 300 includes one or more units of memory 306, such as a main memory, which is coupled to I/O subsystem 302 for electronically digitally storing data and instructions to be executed by processor 304. Memory 306 may include volatile memory such as various forms of random-access memory (RAM) or other dynamic storage device. Memory 306 also may be used for storing temporary variables or other intermediate information during execution of instructions to be executed by processor 304. Such instructions, when stored in non-transitory computer-readable storage media accessible to processor 304, can render computer system 300 into a special-purpose machine that is customized to perform the operations specified in the instructions.

Computer system 300 further includes non-volatile memory such as read only memory (ROM) 308 or other static storage device coupled to I/O subsystem 302 for storing information and instructions for processor 304. The ROM 308 may include various forms of programmable ROM (PROM) such as erasable PROM (EPROM) or electrically erasable PROM (EEPROM). A unit of persistent storage 310 may include various forms of non-volatile RAM (NVRAM), such as FLASH memory, or solid-state storage, magnetic disk or optical disk such as CD-ROM or DVD-ROM and may be coupled to I/O subsystem 302 for storing information and instructions. Storage 310 is an example of a non-transitory computer-readable medium that may be used to store instructions and data which when executed by the processor 304 cause performing computer-implemented methods to execute the techniques herein.

The instructions in memory 306, ROM 308 or storage 310 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 300 may be coupled via I/O subsystem 302 to at least one output device 312. In one embodiment, output device 312 is a digital computer display. Examples of a display that may be used in various embodiments include a touch screen display or a light-emitting diode (LED) display or a liquid crystal display (LCD) or an e-paper display. Computer system 300 may include other type(s) of output devices 312, alternatively or in addition to a display device. Examples of other output devices 312 include printers, ticket printers, plotters, projectors, sound cards or video cards, speakers, buzzers or piezoelectric devices or other audible devices, lamps or LED or LCD indicators, haptic devices, actuators or servos.

At least one input device 314 is coupled to I/O subsystem 302 for communicating signals, data, command selections or gestures to processor 304. Examples of input devices 314 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 316, which may perform cursor control or other automated control functions such as navigation in a graphical interface on a display screen, alternatively or in addition to input functions. Control device 316 may be a touchpad, a mouse, a trackball, or cursor direction keys for communicating direction information and command selections to processor 304 and for controlling cursor movement on display 312. The input device may have at least two degrees of freedom in two axes, a first axis, for example, x, and a second axis, for example, y, that allows the device to specify positions in a plane. Another type of input device is a wired, wireless, or optical control device such as a joystick, wand, console, steering wheel, pedal, gearshift mechanism or other type of control device. An input device 314 may include a combination of multiple different input devices, such as a video camera and a depth sensor.

In another embodiment, computer system 300 may comprise an internet of things (IoT) device in which one or more of the output device 312, input device 314, and control device 316 are omitted. Or, in such an embodiment, the input device 314 may comprise one or more cameras, motion detectors, thermometers, microphones, seismic detectors, other sensors or detectors, measurement devices or encoders and the output device 312 may comprise a special-purpose display such as a single-line LED or LCD display, one or more indicators, a display panel, a meter, a valve, a solenoid, an actuator or a servo.

When computer system 300 is a mobile computing device, input device 314 may comprise a global positioning system (GPS) receiver coupled to a GPS module that is capable of triangulating to a plurality of GPS satellites, determining and generating geo-location or position data such as latitude-longitude values for a geophysical location of the computer system 300. Output device 312 may include hardware, software, firmware and interfaces for generating position reporting packets, notifications, pulse or heartbeat signals, or other recurring data transmissions that specify a position of the computer system 300, alone or in combination with other application-specific data, directed toward host 324 or server 330.

Computer system 300 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 300 in response to processor 304 executing at least one sequence of at least one instruction contained in main memory 306. Such instructions may be read into main memory 306 from another storage medium, such as storage 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 310. Volatile media includes dynamic memory, such as memory 306. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 302. Transmission media can also take the form of acoustic or light waves, such as those generated during radio-wave and infra-red data communications.

Various forms of media may be involved in carrying at least one sequence of at least one instruction to processor 304 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 300 can receive the data on the communication link and convert the data to a format that can be read by computer system 300. For instance, a receiver such as a radio frequency antenna or an infrared detector can receive the data carried in a wireless or optical signal and appropriate circuitry can provide the data to I/O subsystem 302 such as place the data on a bus. I/O subsystem 302 carries the data to memory 306, from which processor 304 retrieves and executes the instructions. The instructions received by memory 306 may optionally be stored on storage 310 either before or after execution by processor 304.

Computer system 300 also includes a communication interface 318 coupled to bus 302. Communication interface 318 provides a two-way data communication coupling to network link(s) 320 that are directly or indirectly connected to at least one communication networks, such as a network 322 or a public or private cloud on the Internet. For example, communication interface 318 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 322 broadly represents a local area network (LAN), wide-area network (WAN), campus network, internetwork or any combination thereof. Communication interface 318 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 318 sends and receives electrical, electromagnetic or optical signals over signal paths that carry digital data streams representing various types of information.

Network link 320 typically provides electrical, electromagnetic, or optical data communication directly or through at least one network to other data devices, using, for example, satellite, cellular, Wi-Fi, or BLUETOOTH technology. For example, network link 320 may provide a connection through a network 322 to a host computer 324.

Furthermore, network link 320 may provide a connection through network 322 or to other computing devices via internetworking devices and/or computers that are operated by an Internet Service Provider (ISP) 326. ISP 326 provides data communication services through a world-wide packet data communication network represented as internet 328. A server computer 330 may be coupled to internet 328. Server 330 broadly represents any computer, data center, virtual machine or virtual computing instance with or without a hypervisor, or computer executing a containerized program system such as DOCKER or KUBERNETES. Server 330 may represent an electronic digital service that is implemented using more than one computer or instance and that is accessed and used by transmitting web services requests, uniform resource locator (URL) strings with parameters in HTTP payloads, API calls, app services calls, or other service calls. Computer system 300 and server 330 may form elements of a distributed computing system that includes other computers, a processing cluster, server farm or other organization of computers that cooperate to perform tasks or execute applications or services. Server 330 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 330 may comprise a web application server that hosts a presentation layer, application layer and data storage layer such as a relational database system using structured query language (SQL) or no SQL, an object store, a graph database, a flat file system or other data storage.

Computer system 300 can send messages and receive data and instructions, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage 310, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 304. While each processor 304 or core of the processor executes a single task at a time, computer system 300 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

What is claimed is:

1. A computer-implemented method comprising:
receiving, at a computer system, shipping data corresponding to a supplying entity and one or more shipping entities involved in commercial transport of a first plurality of items, during a first time period, and a second plurality of items, during a second time period, on behalf of the supplying entity;
wherein the first plurality of items is different than the second plurality of items and the first time period is different than the second time period;
determining, by the computer system, from the shipping data, first utilization data for the supplying entity, wherein the first utilization data comprises one or more first usage values specifying a quantity of items of the first plurality of items shipped by each shipping entity of the one or more shipping entities on behalf of the supplying entity during the first time period;
determining, by the computer system, from the shipping data, second utilization data for the supplying entity, wherein the second utilization data comprises one or more second usage values specifying a quantity of items of the second plurality of items shipped by each shipping entity of the one or more shipping entities on behalf of the supplying entity during the second time period;
determining, by the computer system, from the first utilization data and the second utilization data, difference utilization data for the supplying entity, wherein the difference utilization data comprises one or more differences between the first usage values and the second usage values; and
generating, by the computer system, a graphical visual representation of the difference utilization data, wherein the graphical visual representation of the difference utilization data visually depicts a change in utilization by the supplying entity of the one or more shipping entities between the first time period and the second time period.

2. The computer-implemented method of claim 1, wherein:
the first utilization data comprises first percentage values corresponding to a percentage of items of the plurality of items that each of the one or more shipping entities has shipped for the supplying entity during the first time period;
the second utilization data comprises second percentage values corresponding to the percentage of items of the plurality of items that each of the one or more shipping entities has shipped for the supplying entity during the first time period;
the difference utilization data comprises a delta value corresponding to a degree of change between the first percentage values and the second percentage values;
the graphical visual representation comprises a graph showing one or more determined delta values.

3. The computer-implemented method of claim 1, further comprising:
determining, by the computer system, from the shipping data, third utilization data for the supplying entity, wherein the third utilization data comprises one or more usage values specifying the quantity of items of the plurality of items shipped by each of the one or more shipping entities during a third time period;
wherein the difference utilization data comprises one or more differences in usage values between the first time period, the second time period, and the third time period;
wherein the graphical visual representation of the difference utilization data corresponds to a degree of change determined between the first time period, the second time period, and the third time period.

4. The computer-implemented method of claim 1, further comprising:
receiving, by the computer system, parameterization data specifying a subset of the difference utilization data to be generated in the graphical visual representation;
updating, by the computer system, the graphical visual representation to include only difference utilization data specified in the parameterization data.

5. The computer-implemented method of claim 4, wherein:
the parameterization data comprises a subset of shipping entities of the one or more shipping entities;
updating the graphical visual representation comprises displaying only difference utilization data determined using the subset of shipping entities.

6. The computer-implemented method of claim 1, further comprising:
receiving, by the computer system, threshold data specifying one or more threshold values corresponding to values of the difference utilization data used in generating the graphical visual representation;
updating, by the computer system, the graphical visual representation to include only difference utilization data having values exceeding the corresponding threshold value in the threshold data.

7. The computer-implemented method of claim 1, further comprising:
receiving, by the computer system, historical difference utilization data for the supplying entity;
determining, by the computer system, from the shipping data and the historical difference utilization data, expected difference utilization data, wherein the expected difference utilization data comprises one or more expected differences in usage values during a future time period.

8. The computer-implemented method of claim 7, further comprising:
determining, by the computer system, from the expected difference utilization data, an expected volatility value, wherein the expected volatility value specifies an expected degree of change in shipping rates during the future time period;
generating, by the computer system, based on the expected volatility value, a shipping recommendation for one shipping entity of the one or more shipping entities, the shipping recommendation comprising a likelihood that the one shipping entity will be involved in commercial transport of a subset of items of the plurality of items.

9. The computer-implemented method of claim 8, further comprising:
determining, by the computer system, that the expected volatility value exceeds a permissible volatility threshold.
in response to determining that the expected volatility value exceeds a permissible volatility threshold, updating, by the computer system, one or more shipping contracts between the supplying entity and one or more shipping entities such that the expected volatility value no longer exceeds the permissible volatility threshold.

10. The computer-implemented method of claim 1, wherein:
the difference utilization data comprises individual entity data specifying a degree of change in shipping rates for each shipping entity of the one or more shipping entities;
the generated graphical visual representation includes visual representations of the individual entity data for each shipping entity of the one or more shipping entities.

11. One or more non-transient computer-readable storage media comprising instructions which, when executed by a processor, cause the processor to:
receive, at a computer system, shipping data corresponding to a supplying entity and one or more shipping entities involved in commercial transport of a first plurality of items, during a first time period, and a second plurality of items, during a second time period, on behalf of the supplying entity;
wherein the first plurality of items is different than the second plurality of items and the first time period is different than the second time period;
determine, by the computer system, from the shipping data, first utilization data for the supplying entity, wherein the first utilization data comprises one or more first usage values specifying a quantity of items of the first plurality of items shipped by each shipping entity of the one or more shipping entities on behalf of the supplying entity during the first time period;
determine, by the computer system, from the shipping data, second utilization data for the supplying entity, wherein the second utilization data comprises one or more second usage values specifying a quantity of items of the second plurality of items shipped by each shipping entity of the one or more shipping entities on behalf of the supplying entity during the second time period;
determine, by the computer system, from the first utilization data and the second utilization data, difference utilization data for the supplying entity, wherein the difference utilization data comprises one or more differences between the first usage values and the second usage values; and
generate, by the computer system, a graphical visual representation of the difference utilization data, wherein the graphical visual representation of the difference utilization data visually depicts a change in utilization by the supplying entity of the one or more shipping entities between the first time period and the second time period.

12. The non-transient computer-readable storage media of claim 11, wherein:
the first utilization data comprises first percentage values corresponding to a percentage of items of the plurality of items that each of the one or more shipping entities has shipped for the supplying entity during the first time period;
the second utilization data comprises second percentage values corresponding to the percentage of items of the plurality of items that each of the one or more shipping entities has shipped for the supplying entity during the first time period;
the difference utilization data comprises a delta value corresponding to a degree of change between the first percentage values and the second percentage values;
the graphical visual representation comprises a graph showing one or more determined delta values.

13. The non-transient computer-readable storage media of claim 11, further comprising instructions which, when executed by the processor cause the processor to:
determine, by the computer system, from the shipping data, third utilization data for the supplying entity, wherein the third utilization data comprises one or more usage values specifying the quantity of items of the plurality of items shipped by each of the one or more shipping entities during a third time period;
wherein the difference utilization data comprises one or more differences in usage values between the first time period, the second time period, and the third time period;
wherein the graphical visual representation of the difference utilization data corresponds to a degree of change determined between the first time period, the second time period, and the third time period.

14. The non-transient computer-readable storage media of claim 11, further comprising instructions which, when executed by the processor cause the processor to:
receive, by the computer system, parameterization data specifying a subset of the difference utilization data to be generated in the graphical visual representation;
update, by the computer system, the graphical visual representation to include only difference utilization data specified in the parameterization data.

15. The non-transient computer-readable storage media of claim 11, wherein:
the parameterization data comprises a subset of shipping entities of the one or more shipping entities;
updating the graphical visual representation comprises displaying only difference utilization data determined using the subset of shipping entities.

16. The non-transient computer-readable storage media of claim 11, further comprising instructions which, when executed by the processor cause the processor to:
receive, by the computer system, threshold data specifying one or more threshold values corresponding to values of the difference utilization data used in generating the graphical visual representation;
update, by the computer system, the graphical visual representation to include only difference utilization data having values exceeding the corresponding threshold value in the threshold data.

17. The non-transient computer-readable storage media of claim 11, further comprising instructions which, when executed by the processor cause the processor to:
receive, by the computer system, historical difference utilization data for the supplying entity;
determine, by the computer system, from the shipping data and the historical difference utilization data, expected difference utilization data, wherein the expected difference utilization data comprises one or more expected differences in usage values during a future time period.

18. The non-transient computer-readable storage media of claim 17, further comprising instructions which, when executed by the processor cause the processor to:
determine, by the computer system, from the expected difference utilization data, an expected volatility value, wherein the expected volatility value specifies an expected degree of change in shipping rates during the future time period;
generate, by the computer system, based on the expected volatility value, a shipping recommendation for one shipping entity of the one or more shipping entities, the shipping recommendation comprising a likelihood that the one shipping entity will be involved in commercial transport of a subset of items of the plurality of items.

19. The non-transient computer-readable storage media of claim 18, further comprising instructions which, when executed by the processor cause the processor to:
determine, by the computer system, that the expected volatility value exceeds a permissible volatility threshold.
in response to determining that the expected volatility value exceeds a permissible volatility threshold, update, by the computer system, one or more shipping contracts between the supplying entity and one or more shipping entities such that the expected volatility value no longer exceeds the permissible volatility threshold.

20. The non-transient computer-readable storage media of claim 11, wherein:
the difference utilization data comprises individual entity data specifying a degree of change in shipping rates for each shipping entity of the one or more shipping entities;
the generated graphical visual representation includes visual representations of the individual entity data for each shipping entity of the one or more shipping entities.
